(19) United States
(12) Patent Application Publication
(10) Pub. No.: US 2006/0102005 A1
(43) Pub. Date: May 18, 2006

(54) Cyclone dust-collecting apparatus

(75) Inventors: Jang-keun Oh, Gwangju-city (KR); Hyun-ju Lee, Gwangiu-city (KR)

Correspondence Address: LADAS & PARRY LLP, 224 SOUTH MICHIGAN AVENUE, SUITE 1600, CHICAGO, IL, 60604, US

(73) Assignee: SAMSUNG GWANGJU ELECTRONICS CO., LTD.

(21) Appl. No.: 11/076,320

(22) Filed: Mar. 9, 2005

(30) Foreign Application Priority Data
Nov. 15, 2004 (KR) 2004-93151

(51) Int. Cl. B01D 46/00

(52) U.S. Cl. 96/385; 55/337

(57) ABSTRACT

A cyclone dust-collecting apparatus comprises: a cyclone body having a suction passage formed therein; an upper cover disposed on an upper portion of the cyclone body; a dirt receptacle disposed under the cyclone body; and a noise-reducing member nested in the cyclone body in contact with an inner surface of the cyclone body, wherein dust-laden air flowing through the suction passage collides with the noise-reducing member so that a noise can be reduced.

### CROSS-REFERENCE TO RELATED APPLICATIONS

This application claims the benefit of Korean Patent Application No. 2004-93151, filed on Nov. 15, 2004, in the Korean Intellectual Property Office, the disclosure of which is incorporated herein by reference in its entirety.

### FIELD OF THE INVENTION

The present invention relates to a vacuum cleaner, and more particularly, to a cyclone dust-collecting apparatus for separating dust from dust-laden air by using a centrifugal force.

### BACKGROUND OF THE INVENTION

A cyclone dust-collecting apparatus comprises a cyclone body, an upper cover having a discharge passage connected to an upper portion of the cyclone body, and a dust-collecting receptacle connected to a lower portion of the cyclone body to collect separated dust. The cyclone body has a suction passage formed in a side thereof, for drawing in dust-laden air and allowing the dust-laden air to whirl in the cyclone body. A suction passage fluidly communicates with an extension pipe and a suction brush. Dust-laden air flows into the cyclone body through the suction brush, the extension pipe and the suction passage and swirls in the cyclone body, thereby being separated from the dust. The separated dust is collected in the dust-collecting receptacle, while the dust-removed air is discharged from the cyclone-dust collecting apparatus through the discharge passage.

However, when dust-laden air flows from the relatively narrow extension pipe and the suction passage into the relatively broad cyclone body, the air current speed changes due to the cyclone body's volume, which causes noise. Dust-laden air can collide with an inner surface of the cyclone body or rub against the cyclone body, which also causes noise.

Noise becomes more problematic when a cyclone dust-collecting apparatus is mounted in a sealed cleaner body. Vacuum cleaners that use a cyclone dust-collecting apparatus are therefore relatively noisy.

In order to solve the foregoing noise problem, the Korean Patent Application No 2003-0036608 discloses a cyclone dust-collecting apparatus having a porous noise reducing substance inserted to a suction passage. The porous noise reducing substance can reduce noise in the suction passage, but noise occurring in the cyclone body is still considered by many to be objectionable.

### SUMMARY OF THE INVENTION

The present invention has been developed in order to solve the above problem in the related art. Accordingly, an aspect of the present invention is to provide a cyclone dust-collecting apparatus capable of reducing noise.

The above aspect is achieved by providing a cyclone dust-collecting apparatus comprising a cyclone body having a suction passage formed therein; an upper cover disposed on an upper portion of the cyclone body; a dirt receptacle disposed under the cyclone body; and a noise-reducing member nested in the cyclone body in contact with an inner surface of the cyclone body. Dust-laden air flowing through the suction passage collides with the noise-reducing member so that noise is reduced.

The noise-reducing member comprises: a cylindrical part; and a cut-off part formed at a side of the cylindrical part to help the dust-laden air flowing through the suction passage smoothly advance. The noise-reducing member may be removably mounted in the cyclone body in contact with the inner surface of the cyclone body. The noise-reducing member is preferably made of a porous material.

### BRIEF DESCRIPTION OF THE DRAWING FIGURES

The above aspects and other advantages of the present invention will be more apparent by describing an embodiment of the present invention with reference to the accompanying drawing figures, in which:

FIG. 1 is a perspective view showing a vacuum cleaner employing a cyclone dust-collecting apparatus according to an embodiment of the present invention;

FIG. 2 is an exploded perspective view showing the cyclone dust-collecting apparatus of FIG. 1;

FIG. 3 is a view showing a noise reducing member inserted in a cyclone body of FIG. 2; and

FIG. 4 is a side section view taken along line IV-IV of FIG. 1.

In the drawing figures, it should be understood that like reference numerals refer to like features and structures.

### DETAILED DESCRIPTION OF A PREFRRED EMBODIMENT

Hereinafter, a cyclone dust-collecting apparatus according to an embodiment of the present invention will now be described in detail with reference to the accompanying drawing figures.

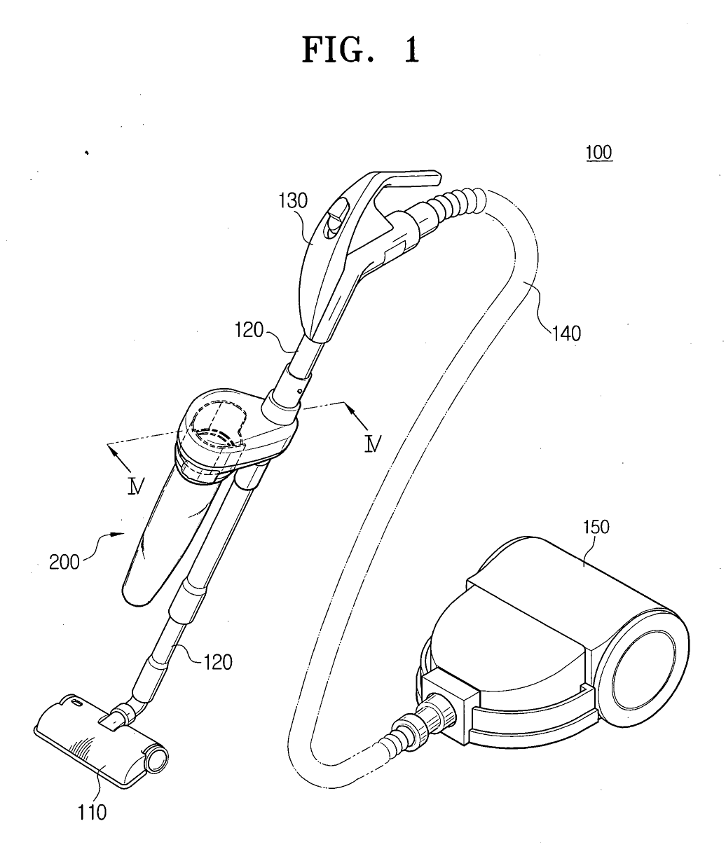

FIG. 1 illustrates a vacuum cleaner 100 employing a cyclone dust-collecting apparatus 200 according to a preferred embodiment. The vacuum cleaner 100 comprises a cleaner body 150, a suction brush 110 for drawing in dirt from a surface to be cleaned, a manipulation part or control 130 for manipulating the vacuum cleaner 100, an extension pipe 120 connecting the suction brush 110 and the manipulation part 130, a flexible hose 140 connecting the manipulation part 130 and the cleaner body 150, and the cyclone dust-collecting apparatus 200.

In a preferred embodiment, the cyclone dust-collecting apparatus 200 is removably mounted on the extension pipe 120. According to another embodiment, the cyclone dust-collecting apparatus 200 is removably mounted in the cleaner body 150. According to yet another embodiment, the vacuum cleaner 100 has a dust bag mounted in the cleaner body 150 and the cyclone dust-collecting apparatus 200 disposed on the extension pipe 120.

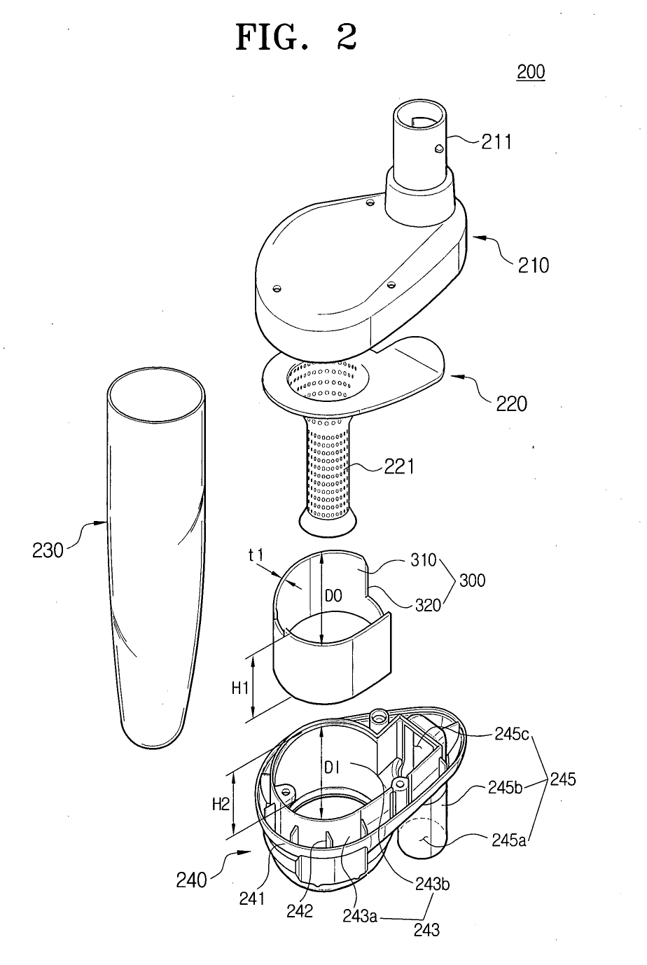

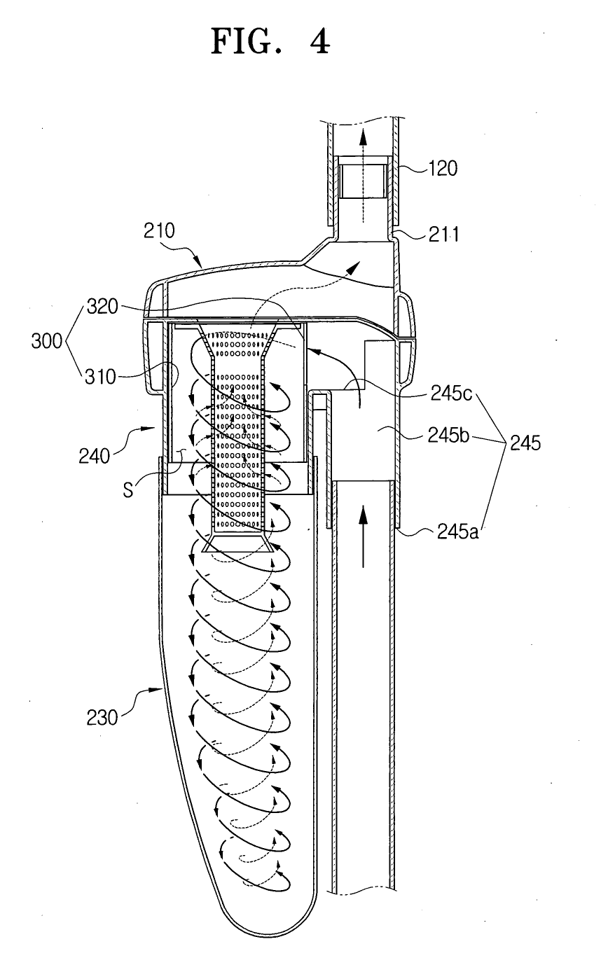

Referring now to FIG. 2, the cyclone dust-collecting apparatus 200 comprises an upper cover 210, a grill 220, a dirt receptacle 230, a cyclone body 240, and a noise-reducing member 300. The upper cover 210 is shaped in on oblong shape and covers an upper opening of the cyclone body 240. The upper cover 210 forms a closed space S (see FIG. 4) in the cyclone body 240 in cooperation with the dirt receptacle 230 and a sidewall 243 to centrifugally separate dirt and collect the separated dirt in the space S. For this, the upper cover 210 is secured to the upper portion of the cyclone body 240 by a screw. The upper cover 210 may be formed integrally with the cyclone body 240. However, it is preferable to fabricate the cyclone body 240 and the upper cover 210 separately for the convenience of maintenance and repair.

The upper cover 210 includes an air discharge passage 211 and is connected to the extension pipe 120 (see FIG. 1). Filtered air is drawn through the cyclone dust-collecting apparatus 200 and into the discharge passage 211.

The grill 220, the shape of which resembles a cylinder, is disposed under the upper cover 210 and positioned in the middle of the closed space S (see FIG. 4) formed by the upper cover 210 in cooperation with the dirt receptacle 230 and the sidewall 243. As shown in FIG. 2, the grill 220 has a plurality of grill perforations 221 formed thereon. Dirt that has not been centrifugally separated is caught or trapped by the grill perforations 221.

The dirt receptacle 230 disposed under the cyclone body 240 is cylindrically shaped. It forms the closed space S (see FIG. 4) in the cyclone body 240 in cooperation with the upper cover 210 and the sidewall 243.

For this, the dirt receptacle 230 is removably disposed under the cyclone body 240. Accordingly, when the dirt receptacle 230 is full of dirt, it can be detached from the cyclone body 240 and emptied. In the preferred embodiment, the dirt receptacle 230 is made of transparent material such as transparent acryl so that a user can easily check the amount of collected dirt.

The cyclone body 240 comprises an upper circumferential edge 241, supplementary strengthening ribs 242, a sidewall 243 and a suction passage 245.

The upper circumferential edge 241 mates with a complementary surface on the underside of the upper cover 210 to enclose the sidewall 243 and thereby strengthen the cyclone body 240.

The supplementary ribs 242 are disposed between the edge 241 and the sidewall 243, each of which has a substantially trapezoid shape. The supplementary ribs 242 support the sidewall 243 and the edge 241 to strengthen the cyclone body 240.

In the embodiment shown, the edge 241 and the supplementary rib 242 are suggested, however, they are not necessarily required. The cyclone body 240 may consist of only the sidewall 243.

The sidewall 243 acts as a frame for the cyclone body 240 and has a generally cylindrical shape. The sidewall 243 forms the closed space S (see FIG. 4) in the cyclone body 240 in cooperation with the upper cover 210 and the dirt receptacle 230. As shown in FIG. 2, the sidewall 243 includes an outer surface 243a and an inner surface 243b. The noise-reducing member 300 is mounted in the cyclone body 240 in contact with the inner surface 243b of the sidewall 243. The noise-reducing member 300 and a mounting method thereof will be described below.

The suction passage 245 is located on a lower portion of the cyclone body 240 and carries dust-laden air that has passed through the extension pipe 120 into the cyclone dust-collecting apparatus 200. As shown, the suction passage 245 includes an inlet 245a connected to the extension pipe 120 (see FIG. 1), an outlet 245c connected to the sidewall 243, and a connection pipe 245b connecting the inlet 245a and the outlet 245c.

The suction passage 245 may be formed in the upper cover 210, but it is preferred that the suction passage 245 is formed in the cyclone body 240 to increase a noise absorption efficiency, because the noise-reducing element 300 is mounted in the cyclone body 240. Stated alternatively since the suction passage 245 is formed in the cyclone body 240, the dust-laden air collides first with the noise-reducing member 300 mounted in the cyclone body 240. Therefore, a noise occurring due to the collision or the rubbing can be reduced more effectively, and a noise occurring due to a change of air current can be also reduced.

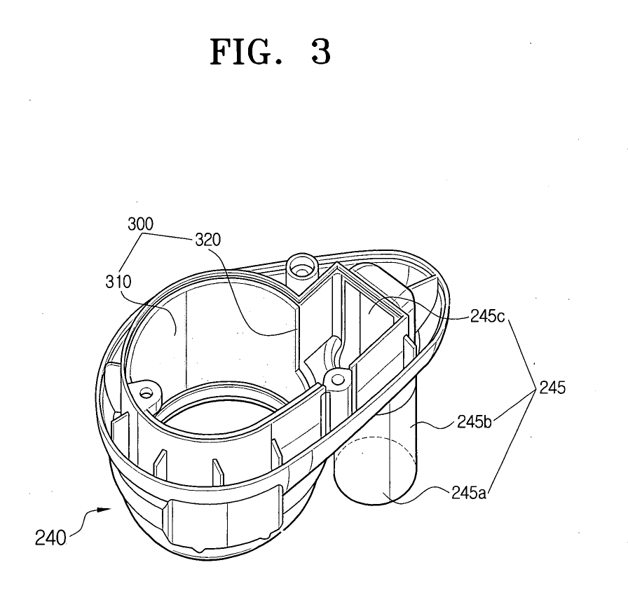

Referring to FIGS. 2 and 3, the noise-reducing member 300 includes a cylindrical part 310 and a cut-off part 320. The cylindrical part 310 is nested into the cyclone body 240 and into contact with the inner surface 243b of the cyclone body 240, thereby protecting the dust-laden air flowing from the outlet 245c of the suction passage 245 from directly colliding with the inner surface 243b.

Preferably, a thickness t1 of the cylindrical part 310 is from 0.05 to 0.15 times an inner diameter DI of the cyclone body 240 in order to form the space S (see FIG. 4) in the cyclone body 240 sufficient to centrifugally separate and collect the dust.

A height H1 of the cylindrical part 310 is from 0.7 to 1.0 times a height H2 of the cyclone body 240 in order for the cylindrical part 310 to be completely nested in the cyclone body 240. Accordingly, noise reduction efficiency increases.

It is possible that the cylindrical part 310 is nested in the upper cover 210 and the dirt receptacle 230, however, as mentioned above, it is preferred that the cylindrical part 310 is nested only in the cyclone body 240 in contact with the inner surface 243b because it is the inner surface 243b of the cyclone body 240 that the dust-laden air passing through the suction passage 245 firstly collides with or rubs against. This construction can also achieve a simplified construction and a cost reduction.

The cut-off part 320 is formed by cutting off a part from the cylindrical part 310 so that the dust-laden air discharged from the outlet 245c of the suction passage 245 smoothly flows into the cyclone body 240. For this, the noise-reducing member 300 is nested in the cyclone body 240 in so a manner that the cut-off part 320 faces the outlet 245c of the suction passage 245.

Due to the presence of the cut-off part 320 facing the outlet 245c of the suction passage 245, the dust-laden air passing through the outlet 245c of the suction passage 245 is smoothly guided to the cylindrical part 310. The cut-off part 320 is small so that the cylindrical part 310 occupies much more area in the noise-reducing member 300 than the cut-off part 320. The cut-off part 320 takes various formations such as a circle or a triangle.

The noise-reducing member 300 having the above construction is nested in the cyclone body 240 in contact with the inner surface 243b except for an area fluidly communicating with the suction passage 245. This area is a rectangular space connecting the sidewall 243 and the outlet 245c.

The noise-reducing member 300 is installed in the cyclone body 240 in such a manner that the cylindrical part 310 is brought into contact with the inner surface 243b. Another method of installing the noise reducing member 300 is to removably mount the cyclone body 240 in such a manner that the cylindrical part 310 pushes the inner surface 243b of the cyclone body 240 with a predetermined force. Among these methods, the latter method is preferred for the easy separation of the noise-reducing member 300 and convenience of maintenance.

In case of removably mounting the noise-reducing member 300 in the cyclone body 240, an outer diameter D0 of the cylindrical part 310 is larger than an inner diameter DI of the cyclone body 240 to fit compactly the noise-reducing member 300 in the cyclone body 240. For example, the outer diameter D0 of the cylindrical part 310 is from 1.1 to 1.2 times the inner diameter DI of the cyclone body 240.

The noise-reducing member 300 is made of porous material such as a porous plastic, sponge, or urethane. Porous plastic is more preferable in view of a high noise-absorption efficiency. The porous plastic is formed by evenly mixing powders of magnesium and iron with a polyethylene of high density.

Referring to FIGS. 1, 2, and 4, a dust-laden air drawn from a cleaning surface through the suction brush 110 flows into the cyclone dust-collecting apparatus 200 after passing through the extension pipe 120 and the suction passage 245 connected to the extension pipe 120. More specifically, the dust-laden air passes through the inlet 245a, the connection pipe 245b and the outlet 245c of the suction passage 245, passes over the cut-off part 320 of the noise-reducing member 300 and then collides with the cylindrical part 310 of the noise-reducing member 300 or rubs against the cylindrical part 310.

Since the dust-laden air does not directly collide with nor rub against the inner surface 243b of the cyclone body 240, noise is reduced. The noise-reducing member 300 absorbs noise caused by the change of air current when the dust-laden air flows into the cyclone body 240.

Dust-laden air swirls in the closed space S formed by the sidewall 243 of the cyclone body 240, the upper cover 210 and the dirt receptacle 230 at the same time when colliding with or rubbing against the cylindrical part 310 so that the dust and the air are separated from each other. The separated dust is collected in the dust receptacle 230, while the cleaned air passes through the grill perforations 221 of the grill 220 and then is discharged from the dust-collecting apparatus 200 through the discharge passage 211.

Cleaned air flows into the cleaner body 150 after passing through the extension pipe 120 connected to the discharge passage 211 and the flexible hose 140, and is discharged from the cleaner body 150.

According to the cyclone dust-collecting apparatus 200 as described above, the noise-reducing member 300 nested in the cyclone body 240 and in contact with the inner surface 243b of the cyclone body 240, reduces the noise caused by the collision of the dust-laden air with the inner surface 243b. Noise caused by the change of air current of the dust-laden air can be also absorbed and reduced.

Accordingly, a user performs a cleaning effectively in an environment that requires a quiet operation, especially, in the nighttime.

As described above, if the cyclone dust-collecting apparatus 200 is disposed on the extension pipe exposed to the outside, the user is more satisfied with this effect.

What is claimed is:

1. A cyclone dust-collecting apparatus comprising:
a cyclone body having a suction passage formed therein;
an upper cover disposed on an upper portion of the cyclone body;
a dirt receptacle disposed under the cyclone body; and
a noise-reducing member nested in the cyclone body in contact with an inner surface of the cyclone body, wherein dust-laden air flowing through the suction passage collides with the noise-reducing member to reduce noise.

2. The cyclone dust-collecting apparatus as claimed in claim 1, wherein the noise-reducing member comprises:
a cylindrical part; and
a cut-off part formed at a side of the cylindrical part to help dust-laden air flow through the suction passage.

3. The cyclone dust-collecting apparatus as claimed in claim 2, wherein the noise-reducing member is removably mounted in the cyclone body in contact with the inner surface of the cyclone body.

4. The cyclone dust-collecting apparatus as claimed in claim 1, wherein the noise-reducing member is made of porous material.

5. The cyclone dust-collecting apparatus as claimed in claim 1, wherein the cyclone dust-collecting apparatus is disposed on an extension pipe.
